(19) United States
(12) Patent Application Publication
(10) Pub. No.: US 2005/0176419 A1
(43) Pub. Date: Aug. 11, 2005

(54) Method and system for dynamic automatic optimization of CDMA network parameters

(76) Inventors: Anthony A. Triolo, Manalapan, NJ (US); Joseph C. Liberti JR., Howell, NJ (US); John C. Koshy, Jackson, NJ (US)

Correspondence Address: TELCORDIA TECHNOLOGIES, INC., ONE TELCORDIA DRIVE 5G116, PISCATAWAY, NJ, 08854-4157, US

(21) Appl. No.: 11/044,328

(22) Filed: Jan. 27, 2005

Related U.S. Application Data
(60) Provisional application No. 60/540,110, filed on Jan. 27, 2004.

(51) Int. Cl. H04Q 7/20

(52) U.S. Cl. 455/423; 455/446; 455/424; 455/453

(57) ABSTRACT

Our invention is a method and system for solving the problem of blocked calls by load balancing in which overloaded sectors reduce their coverage region, thereby, shedding users, and the surrounding under-loaded sectors increasing their coverage to pick up the shed users. The users are shed from one sector to another by growing or shrinking the relevant sectors through adjustment of the overhead channel power. The overhead channel power allocation parameter is adjustable by the network operator. The setting for the overhead channel power allocation is increased for overloaded sector and decreased for under loaded sector.

### CROSS REFERENCE TO RELATED APPLICATION

This application claims the benefit of U.S. Provisional Application No. 60/540,110, filed Jan. 27, 2004, the contents of which are incorporated herein by reference.

### FIELD OF THE INVENTION

The present invention provides a system and method for dynamically solving the problem of blocked calls in a CDMA cellular system by adjusting load balancing in which overloaded sectors reduce their coverage region, thereby, shedding users, and the surrounding under-loaded sectors increasing their coverage to pick up the shed users.

### BACKGROUND OF THE INVENTION

As wireless communications become more widely used, the demand for limited wireless resources, such as the finite number of frequency bands, time divisions, and/or identifying codes (collectively referred to herein as “channels”) have increased significantly. It should be appreciated that channels may be distinguishable based on the particular air interface standard implemented such as the frequency bands of frequency division multiple access (FDMA), time slots of time division multiple access (TDMA), codes (pseudo random, Walsh, Orthogonal Variable Spreading Factor, etc.) of code division multiple access (CDMA), and the like. In order to more efficiently use these available resources, wireless communication systems typically divide a geographic area into multiple overlapping coverage cells, which are each served by a base station. Each base station typically comprises a tower, one or more antenna, and radio equipment to allow wireless communication devices to connect with the network side of a wireless communications link.

The planning process which defines the deployment and growth of mobile radio networks with respect to forecasted demand usually precedes their operation and management. The planning department uses predictions of traffic and propagation environment to determine the adequate placement of base station transceivers (BTSs) in the intended service area, as well as their configuration. This configuration encompasses issues like power class, antenna type, antenna pointing, or frequency plan, and it results in a large number of parameters that need to be set. Some of these parameters cannot be easily changed once a decision is made (for instance, changing a base station location once the tower is built), whereas other parameters allow changes through simple software updates (for instance, changing the carrier frequency).

Once the planning department has decided on a configuration for the service area, the operations department deploys the plan and the system can go live. At this stage, actual performance measurements can be collected (either through drive-tests, handset measurements, or switch statistics) and fed back to the planning department to validate the predictions. If discrepancies are found (usually in the form of impaired service quality), the planned configuration is fine-tuned and a new configuration is returned to the operations department for deployment. The fine-tuning process is iterated periodically to improve system performance and also to track any changes (for instance, an unexpected increase in volume of calls) that would require a major configuration update.

In FDMA and TDMA cellular networks, system performance relies on frequency reuse; one of the key parameters that need to be optimized is the set of carrier frequencies allocated to each BTS. The reason for the need to allocate frequencies in these networks is that frequencies cannot be universally reused at each BTS without incurring unacceptable interference levels. The license granted a cellular system operator is limited to a finite number of carrier frequencies for use by that operator. Therefore a decision has to be made as to which frequencies can be used in which BTSs so that the interference levels provide acceptable quality, while at the same time maximizing capacity per carrier frequency (by reusing the frequencies as tightly as possible). U.S. Pat. No. 6,832,074 by Borras-Chia et al., entitled “Method and System for Real Time Cellular Network Configuration” recently issue to the assignee of the present application that provided a solution to this above problem.

In CDMA networks however, system performance is affected by sector overloading in hot spots (areas where the number of users demanding service is very high). The overloading condition occurs when the total available power at the sector is less than that required to provide service to all of the users requesting service. Overloading of the sector results in calls being blocked. In CDMA systems, the total power transmitted by any sector is determined by the overhead channels (Pilot, Paging, and Sync channels), and the traffic channels, which carry voice. The power allocated to the overhead channels determines the size of the cell, such that less power shrinks the cell, and more power grows the cell.

Therefore it is an object of the present invention to address the problem of blocked calls by load balancing in which overloaded sectors reduce their coverage region, thereby, shedding users, and the surrounding under-loaded sectors increasing their coverage to pick up the shed users using system-wide optimum that overcomes the inadequacies and deficiencies of the prior art.

### SUMMARY OF THE INVENTION

Our invention is a method and system for solving the problem of blocked calls by load balancing in which overloaded sectors reduce their coverage region, thereby, shedding users, and the surrounding under-loaded sectors increasing their coverage to pick up the shed users. The users are shed from one sector to another by growing or shrinking the relevant sectors through adjustment of the overhead channel power. The overhead channel power allocation parameter is adjustable by the network operator. The setting for the overhead channel power allocation is increased for overloaded sector and decreased for under loaded sector.

### BRIEF DESCRIPTION OF THE DRAWINGS

FIG. 1 illustrates a simplified cellular network

FIG. 2 illustrates a simplified cellular network where the cell sizes have been adjusted in accordance with our inventive method.

FIG. 3 is a high level flow diagram of our inventive process.

FIG. 4 depicts a flow diagram for our method to adjust overhead power levels on the downlink in accordance with our inventive method.

FIG. 5 depicts an application of the trigger thresholds in accordance with our inventive method.

### DETAILED DESCRIPTION

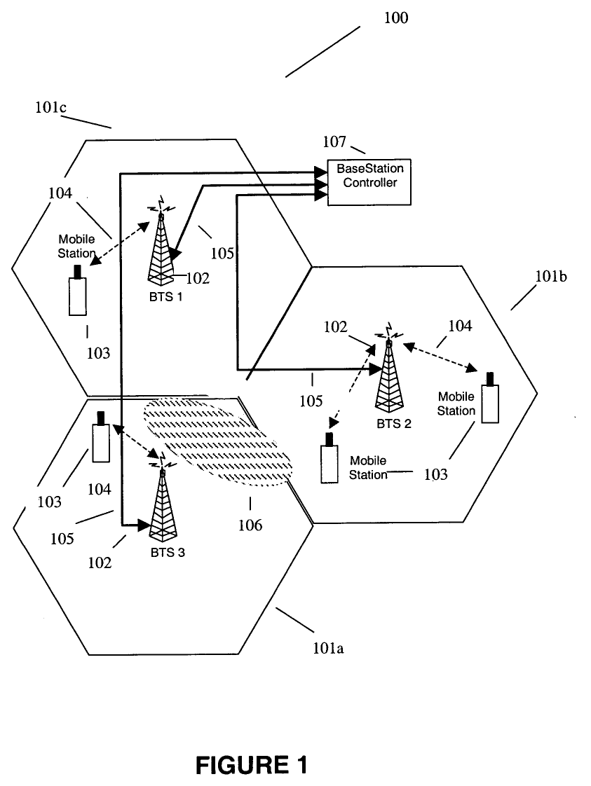

FIG. 1 illustrates a cellular system and its components. This cellular system is comprised of a plurality of transmission areas “cells” 101a, b and c respectfully. Within each cell 101 there is a Base Station Transceiver (BTS) 102 that is in communication with the Mobile Stations (MS) 103 in their cell area 101. The BTS 102 provides the access point for the MS 103 to the telecommunications network. In a simple cellular system, the BTS 102 provides transport, switching and some network management functions. Often a Base Station Controller 107 can provide coordinated management amongst the BTSs 102 over communications links 105. Transmissions from the BTS 102 to the MS 101 are called downlink transmissions. Communications from each MS 102 is established over the radio link 104 to the BTS 103. In a CDMA cellular system, network capacity is usually limited by the downlink versus the uplink power levels because software hand-off as a MS 101 moves to a new BTS cells usually reduces the overall capacity of the downlink. The size of each of the three cells depicted in FIG. 1 is illustrated by the equal size hexagons 101 surrounding each BTS 102. This depiction assumes equal size cells with the number of MSs 102 evenly distributed in each cell. However, the shaded oval 106 depicts a “Hot Spot”—an area with a density of MSs which exceeds the capacity of cell 101a to provide service. As a result individual MS 102 in cell 101a may have calls dropped even though the capacity of the network 100 as a whole has adequate capacity to handle the call traffic from all he MSs 102 currently active in the system. This is due to the fact that the base station is being asked to generate more power than it can produce to provide the required signal-to-interference-and-noise-ratio (SINR) to users on the downlink.

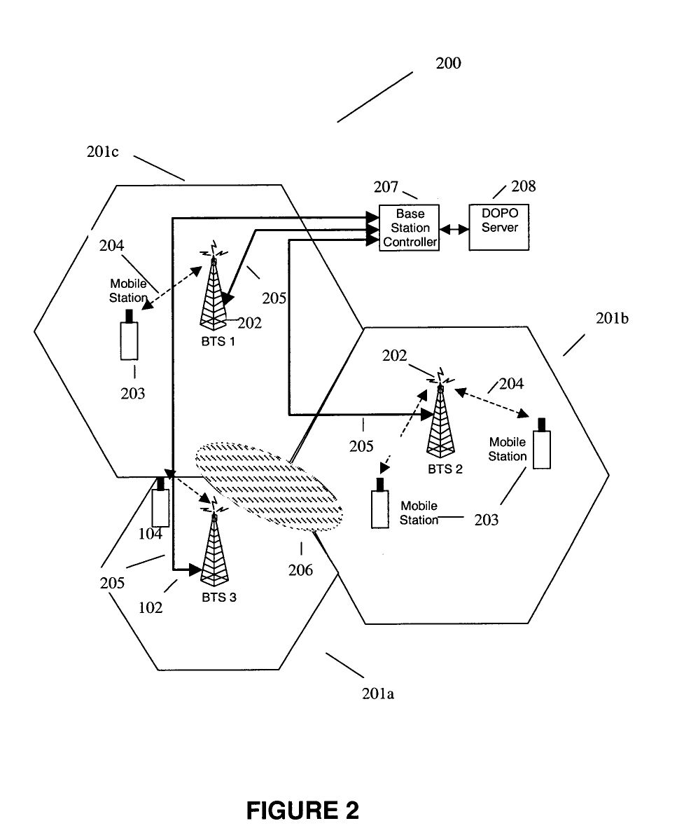

Our invention is a method and system to adjust the size of cells 101a, b and c to equalize amongst cells 101a, 101b and 101c the distribution of MSs in hot spot 106. FIG. 2 illustrates the change in cell sizes resulting from an application of our invention. Our invention uses our inventive downlink overhead power optimization (DOPO) method to adjust the overhead radio signal strengths transmitted from BTS 202 to change the coverage area of each cell size 202a, 202b, and 202c. This algorithm computes new overhead power parameters which shed users from the overloaded cells, and transfer them to under loaded cells. After optimization, the same users are supported; however, all sectors are able to do so without reaching an overload condition. Thus blocking is reduced. As illustrated in FIG. 2, MS 203 are shed from one cell 202 to another by growing or shrinking the relevant cell sizes through adjustment of the overhead channel power. The overhead channel power allocation parameter is adjustable by the network operator. The setting for the overhead channel power allocation is decreased for overloaded cell 202a and increased for under loaded cells 202b and c.

Our invention uses traffic data from the network (based on statistics from the base station controller and BTS) to construct a spatio-temporal model of offered traffic. This traffic data can be provided from the BTS 204 to the base station controller 207. The base station controller may provide this information to the server 208 which uses the received data to construct or update this model. This model describes the variation in offered load as a function of location and time (typically for each hour of the day, and specific to the day of week). The analysis can be done at one time, based on trended historical data, or the preferred method is to perform the analysis on an on-going basis to provide periodic updates to the network. Again referring to FIG. 2, this analysis can be provided in real time in a server 208. This analysis can be updated by using different network parameter settings for the busy hour relative to background levels. As an example, specific settings to support high load predicted events, such as sporting events.

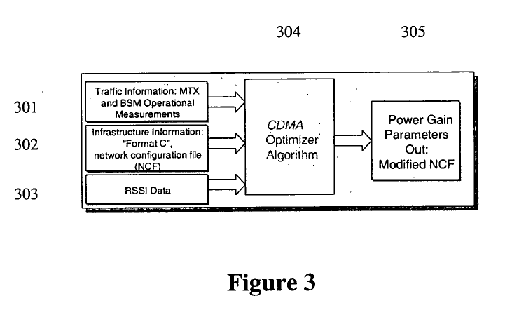

The overall approach of our method is illustrated in FIG. 3. Inputs into the methodology are the traffic data 301, the infrastructure information describing the planned or current network configuration 302, and the current RSSI (Receive Signal Strength Indicator) measurements 303. This data is used to construct the spatio-temporal model of offered traffic.

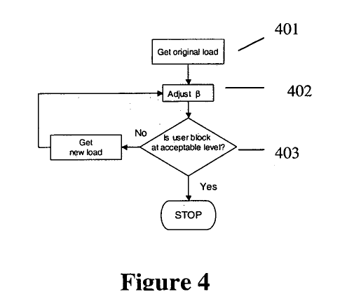

FIG. 4 shows a flow chart depicting the optimization algorithm. First the initial load per cell sector is computed 401. This load is based on the spatio-temporal-teledensity map built from the BTS data. Given this initial load 401, the overhead gain 402 is increased or decreased for a particular sector if its load is below the “increase Trigger” or above the “Decrease Trigger”, respectively. Our process then reviews the system performance data and determines whether the performance of the reconfigured network is in accordance with the performance requirements of the system operator 403. After all of the cell sectors have had an opportunity to change the overhead gain based, the blocked call metric and per-sector load is computed for the new network with the adjusted overhead gains. If the target blocked call level is not met, the gains are again adjusted based on the load of the new network and this procedure continues in an iterative manner 404 till the target blocked call level is achieved.

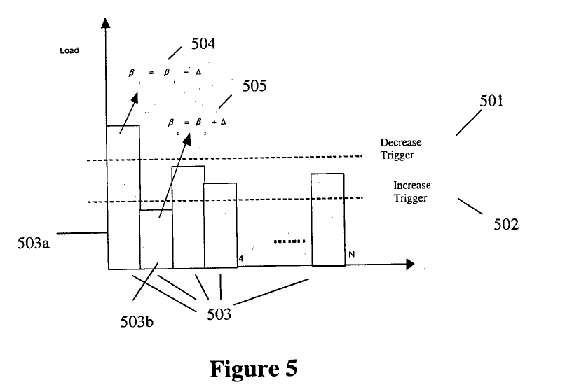

The trigger mechanism of our invention shown in FIG. 5. An increase power level trigger 502 is set based on the network performance requirements set by the user of the system. Similarly, a decrease power level trigger 501 is also set in the system. As illustrated in FIG. 5, the bars depict the traffic load in various cell sectors 503. In cell sector 503a, the load exceeds the decrease power level trigger 501. Accordingly, the overhead power gain parameter is increased as shown by equation 504. Similarly, the load in cell sector 503b is below the increase power level trigger 502, and therefore its overhead power gain parameter is adjusted in accordance with equation 505.

Our invention is applicable to all CDMA technologies, including IS-95, 1XRTT, and W-CDMA. Extensions can also be made to TDMA technologies with forward link power limitations. Besides overhead power, other network features and parameters can be adjusted in the same manner to achieve similar results. These other parameters include: 1) Azimuthal angular extent and shape of sectors which can be adjusted using dynamic antenna systems, 2) Downtilt of antennas, 3) Handoff parameters such as Tadd and Tdrop thresholds in CDMA, or 4) Multi-carrier CDMA sequential loading parameters such as those associated with the MultiCarrier Traffic Allocation (MCTA) approach used in Nortel MTX networks.

In our invention, a controller can be used which is integrated into any cellular providers network. This controller can be used to optimize these features and parameters independently or jointly and it runs as an automated process, continuously or periodically.

While it has been illustrated and described what is at present considered to be the preferred embodiments and methods of the present invention, it will be understood by those skilled in the art that various changes and modifications may be made, and equivalents may be substituted for elements thereof without departing from the true scope of the invention. Moreover, it should be appreciated that the present invention may be used for many different applications besides the frequency allocation problem. For example, the system as described can be used to optimize frequency hopping parameters, base station power settings, or the setting of handover control parameters. Therefore it is intended that the invention not be limited to the particular embodiments and methods disclosed herein, but the invention includes all embodiments falling within the scope of the appended claims.

1. A method for adjusting the cell size in a cellular telecommunications network, comprising the steps of:
identifying a cell where the number of users exceed a threshold;
decreasing the power level of the downlink transmission in said cell; and
increasing the power level of the downlink transmission level in near by cells.

2. The method of claim 1 further included the steps of iteratively repeating the steps of claim 1 until the user traffic in all cells are within performance requirements.

3. A method for determining an optimized load balance in a wireless telecommunications network, comprising the steps of:
measuring at a plurality of base stations the traffic load;
reporting said measurements to a centralized server;
comparing said measured load levels at said base stations to a set of performance levels;
decreasing a power level gain parameter for a base station when said measured load of said base station is above a predefined threshold; and
increasing the power level gain parameter of a base station when said measured load of said base station is below a second predefined threshold.

4. A computer server comprising:
means for receiving performance data from a plurality of cellular radio base stations;
means for storing said performance data;
means for using said performance data for determining new cellular system parameters that improve cellular system performance; and
means for communicating said new cellular system parameters to said plurality of cellular radio base stations.

5. The server of claim 4 wherein said performance data are measured by the traffic load for each base station.

6. The server of claim 5 wherein said determining means further comprises means to adjust cell sizes by decreasing the parameter for overhead power gain for those base stations where said traffic load data is above a predefined threshold.

7. The server of claim 6 wherein said server further comprises the means to adjust cell sizes by increasing the parameter for overhead power gain for those base stations where said traffic load data is below a predefined threshold.

8. The server of claim 5 wherein said new cellular system parameters are overhead power gain levels used by each of said plurality of cellular base stations.

9. A computer program product comprising a computer readable program code means for causing a computer to:
receive from a plurality of cellular base stations traffic load measurements;
create a model of the overall traffic loads in a cellular network from using measured traffic load data from a plurality of said base stations;
identify base stations where there is an overload in user traffic; and
send to said base stations where there is an overload in said traffic, information to reduce the cell size coverage area wherein said traffic load becomes more evenly balanced among said plurality of cell sites.

10. The computer program product of claim 9 where in said computer readable program code further causes a computer to send a plurality of base stations a revised overhead power gain parameter necessary to reduce said cell size.

11. The computer program product of claim 10 where in said computer readable program code further causes a computer to send a plurality of base stations a revised overhead power gain parameter necessary to increase said cell size.

12. The computer program product of claim 11 where in said computer readable program code further causes a computer continually and in real time to adjust said overhead power gain parameters until said measured traffic load in said plurality of base stations is more evenly distributed across said base stations.
